(19) United States
(12) Patent Application Publication
(10) Pub. No.: US 2011/0058696 A1
(43) Pub. Date: Mar. 10, 2011

(54) ADVANCED LOW-POWER TALK-THROUGH SYSTEM AND METHOD

(76) Inventor: Patrick ARMSTRONG, Toronto (CA)

(21) Appl. No.: 12/839,417

(22) Filed: Jul. 20, 2010

Related U.S. Application Data
(60) Provisional application No. 61/260,041, filed on Nov. 11, 2009.
(60) Provisional application No. 61/240,684, filed on Sep. 9, 2009.

(51) Int. Cl. H04R 5/02

(52) U.S. Cl. 381/309

(57) ABSTRACT

A low-power consumption, talk-through system comprising: a headset worn by a user on his head, the headset further comprising: an array of at least 2 sets of 2 ambient sound microphones, each set positionable on each side of the head; a signal processing subsystem adapted to process respective electrical signals from the microphones and to provide respective outputs having acoustical source distance and intensity information; at least 4 acoustical output devices connectable to the signal processing subsystem, the respective acoustical output devices driven by the respective outputs of signal processing subsystem; and no on-board power source, wherein the user is provided with enhanced situational awareness and near human sound localization by the system.

### BENEFIT OF PRIOR APPLICATIONS

This application claims the benefit of US Provisional Applications No. 61260041, filed Nov. 11, 2009 and no. 61240684, filed Sep. 9, 2009 whose disclosures are incorporated herein by reference.

### FIELD AND BACKGROUND OF THE INVENTION

The present invention relates generally to the field of hearing protection, unwanted noise cancelation (ie engine noise-background noise and the like) and voice enhancement systems in noisy and/or acoustically hostile environments and in acoustically quiet environments to afford a user a hearing advantage. More specifically, embodiments of the present invention relate to an advanced system and method to enhance talk-through specifically in military and paramilitary acoustically-hostile environments as well as providing hearing enhancement in acoustically quiet environments.

Conventional hearing protectors used in high noise (or “acoustically-hostile”) environments, such as ear plugs or ear muffs, cause a wearer to lose his ability to hear ambient noise and to localize sounds. More advanced systems have been designed to protect the user's hearing while restoring ambient sound at safe hearing intensity levels by using a microphone to pick up sounds and a speaker to replay sounds inside the physical hearing protector, close to the wearer's eardrum. Such systems have been called “talk-through” systems. The terms “talk-through” and “active listening” are used in the specification and the claims which follow to mean similar systems which protect the user's hearing while providing safe hearing sound levels as described hereinabove.

An article entitled “Headsets” written by Baddeley, whose disclosures is incorporated herein by reference, covering concepts of such systems as well as noting some of the commercially available systems, was published in Special Operations Technology, World's Largest Distributed Special Ops Magazine (online), Special Operations Technology—SOTECH 2009 Volume: 7 Issue: 7 (September) and is included in its entirety in the Appendix of the current application. An additional article entitled, “TCAPS Prepares to Protect and Save”, whose disclosure is incorporated herein by reference, and published on line in SoldierMod, Vol 2, 2009 provides additional information about such systems. The article is likewise included in the Appendix.

Typically, active listening/talk-through systems use an externally mounted microphone on each side of the headset. The position of the microphone is variable. For example, the microphone may be positioned: in front of the headset on the leading edge pointing directly ahead and parallel to the human temples; mounted on the side of the head, pointing almost perpendicularly to the temples; and mounted in the middle of the headset. All of these configurations rely on one microphone to gather acoustical data and a speaker to play acoustical information to the ear. The limitations of using one microphone per side are as follows:

a. Inability/limitation in calculating phase shifts in acoustical sources for calculation sound localization;

b. Inability to gather acoustical data simultaneously from the front, side and back of the headset wearer, resulting in poor situational awareness;

c. Inability/limitation in cancelling unwanted noises.

Recent advances in digital signal processing (DSP) technology use microphone arrays employing two or more microphones. DSP is employed to calculate time differences (ie “phase shifts”) between respective microphone inputs and using respective microphone signals, the direction from which a sound has originated is calculated. This process simulates sound localization of the human ear.

In the specification and the claims which follow hereinbelow, the term “situational awareness”, when used in describing a an active listening/talk—through system used in a hostile acoustical or quiet acoustical environment, is intended to mean the degree afforded the user to discern and discriminate near 360-degree sound sources, according to predetermined parameters. By way of contrast and example, poor situational awareness would be provided by a system that could only sense and provide audio information in one or in a limited direction about the user.

The term “near human sound localization”, as used in the specification and claims which follow, is intended to mean the way an active listening/talk—through system can reproduce audio information to the user so that the timing and/or phase shift of ambient sounds allow the user to readily determine relative distance and direction of one or more sound sources.

Reference is currently made to FIG. 1, which shows qualitative polar coordinate representations 3 and 5 of situational awareness provided by typical prior art talk-through systems. In the polar representations, the user is located at the origin/center of the respective presentation and coordinates are: concentric circles indicative of increased acoustical intensity; and azimuth lines indicative of direction. Representation 3 (also indicated “a”) corresponds to the situation awareness provided by a prior art system having side-mounted microphones whereas representation 5 (also indicated “b”) corresponds to the situation awareness provided by a prior art system having front-mounted microphones—where the terms “side” and “front” refer to the orientation the user's head. The dark/black shading in both representations indicates regions of sensitivity, whereas the unshaded/clear regions are indicative of lower/no sensitivity. It can be seen that both systems have preferred directions of sensitivity and that the overall acoustic environment is not adequately represented by either system.

An example of a system using multiple microphones is Malsano in U.S. Pat. No. 7,502,479, whose disclosure is incorporated herein by reference. Malsano describes a system for analyzing an acoustical environment comprising a least two acoustical to electrical converters (aka ‘microphones’) which generate respective first electric output signals and at least two outputs of the converters. The system provides for a method for discriminating impinging acoustical signals not only as function of the angular impinging direction, but also as a function of the distance of an acoustical signal's source from the individual. Malsano describes a system/method primarily directed to hearing aid systems.

There are additional talk-through systems that utilize additional microphones and/or speakers, among which are: Norholm et al, US Patent Publication no. US2008/00004872 and Baechler, US Patent Publication no. US 2009/0268933, whose disclosures are incorporated herein by reference.

The orientation of microphones of these talk-through systems provide some situational awareness and some near human sound localization for the user—as noted previously hereinabove—and they either have hardware and/or software, typically not integrated into a headset.

Some of the systems have on-board power supplies and/or they use excessive electrical power when connected to other systems. The majority of these talk-through systems interface with additional devices such as but not limited to: PTT (push-to-talk) communication; and other radio systems, inter alia. In most, if not all cases, the need for on-board power (inferring larger power consumption by the respective talk-through systems) and/or the need for additional connections for either software/hardware outside of the talk-through system in order to interface with other devices serves as a source of incompatibility and certainly more complexity and an operational limitation of these systems.

There is therefore a need for an advanced talk-through system having enhanced situational awareness and near human sound localization while also having very low power consumption and high compatibility with outside devices.

### SUMMARY OF THE INVENTION

According to the teachings of the present invention there is provided a low-power consumption, talk-through system comprising: a headset worn by a user on his head, the headset further comprising: an array of at least 2 sets of 2 ambient sound microphones, each set positionable on each side of the head; a signal processing subsystem adapted to process respective electrical signals from the microphones and to provide respective outputs having acoustical source distance and intensity information; at least 4 acoustical output devices connectable to the signal processing subsystem, the respective acoustical output devices driven by the respective outputs of signal processing subsystem; and no on-board power source, wherein the user is provided with enhanced situational awareness and near human sound localization by the system. Preferably, the system power consumption is below a peak value of 6 milliwatts. Most preferably, the system obtains its power from an external device. Typically, the external device is chosen from the list including: a transceiver radio; and a communications device having audio input/output.

Preferably, one or more additional ambient sound microphones are positionable on the headset with orientations chosen from the list including: back of the head and sides of the head. Most preferably, at least one mixing audio output unit is positionable on the headset to receive outputs from the signal processing subsystem and from the external device, the at least one mixing audio output unit connectable to an earphone to provide external device and ambient audible sound to the user. Most preferably, the system obtains its power from an external battery.

According to the teachings of the present invention there is further provided a method for using a low-power consumption talk-through system, the system not having an on-board power source, including the steps of: taking a headset worn by a user on his head; configuring on the headset an array having at least 2 sets of 2 ambient sound microphones positioned on each side of the head; using a signal processing subsystem to process respective electrical signals from the microphones and to provide respective outputs having acoustical source distance and intensity information; and connecting at least 4 acoustical output devices to the signal processing system, the respective acoustical output devices driven by the respective outputs of signal processing subsystem, wherein the user is provided with enhanced situational awareness and near human sound localization by the system. Preferably, the system power consumption is below a peak value of 6 milliwatts. Most preferably, the system obtains its power from an external device. Typically, the external device is chosen from the list including: a transceiver radio; and a communications device having audio input/output.

Preferably, one or more additional ambient sound microphones are positioned on the headset with orientations chosen from the list including: back of the head and sides of the head. Most preferably, at least one mixing audio output unit is positioned on the headset to receive outputs from the signal processing subsystem and from the external device, the at least one mixing audio output unit is connected to an earphone to provide external device and ambient audible sound to the user. Typically, the system obtains its power from an external battery.

According to the teachings of the present invention there is further provided a low-power consumption, talk-through system comprising: a headset worn by a user on his head, the headset further comprising: an array of at least 2 sets of 2 ambient sound microphones, each set positionable on each side of the head; an in-ear earphone adapted to attenuate environmental sound and to provide system audio to the user; and a boom microphone substantially isolated from the user's body vibrations, the boom microphone adapted to attenuate environmental sound and to receive user speech; wherein the user is provided with enhanced situational awareness and near human sound localization by the system.

### BRIEF DESCRIPTION OF THE DRAWINGS AND APPENDICES

The invention is herein described, by way of example only, with reference to the accompanying drawings, wherein:

FIG. 1 is a polar coordinate qualitative representation of direction and intensity situational awareness provided by typical prior art talk-through systems;

FIGS. 2A and 2B are isometric pictorial representations showing a user wearing a low-power consumption, talk-through system and details of the system, respectively, in accordance with embodiments of the current invention;

FIG. 3 is a polar coordinate qualitative representation of direction and intensity situational awareness provided in accordance with embodiments of the current invention;

FIGS. 4 and 5 are pictorial and schematic representations, respectively, of the system of FIGS. 3A and 3B, in accordance with embodiments of the current invention;

FIG. 6 is a pictorial representation of the mixing audio output unit, with external cover removed, in accordance with embodiments of the current invention; and

FIG. 7 is a block diagram of the low-power consumption, talk-through system of FIGS. 3A, 3B, 4, and 5, in accordance with embodiments of the current invention.

### DETAILED DESCRIPTION OF THE PREFERRED EMBODIMENTS

In the specification and the claims which follow hereinbelow, the term “low power” or “low power consumption” when used in describing the power consumption of a talk-through system is intended to mean operation wherein the peak power consumption level is below 6 mW.

In the specification and the claims which follow hereinbelow, the term “microphone” is intended to mean an acoustical-to-electric converter for generating an electrical signal from an acoustical signal of one or more acoustical sources.

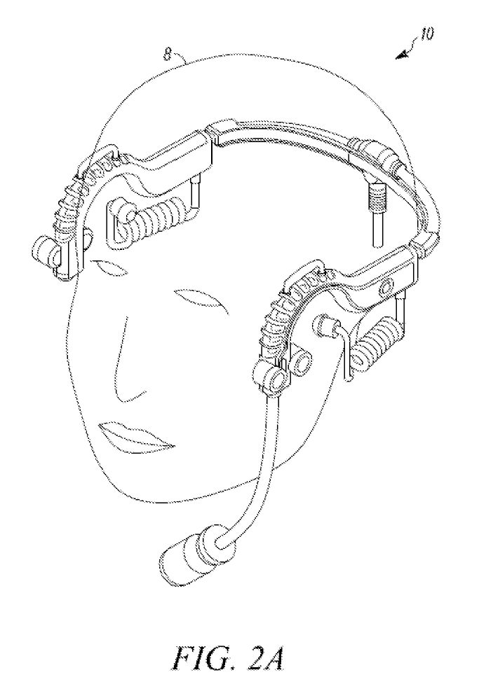

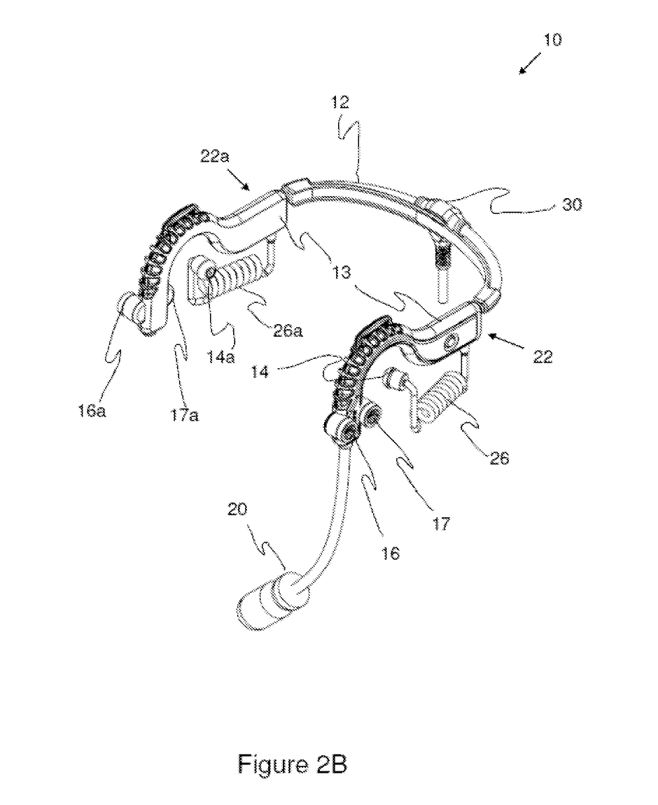

Reference is presently made to FIGS. 2A and 2B, which are isometric pictorial representations showing a user 8 wearing a low-power consumption, talk-through system 10 and details of the system, respectively, in accordance with embodiments of the current invention.

System 10 is essentially a headset worn on the head and extending about the rear of the head and supported additionally above the user's ears, as shown in the figure. The system is comprised of a rear head support 12 and two side/ear supports 13. Earphones 14 and 14a are connected to the side/ear supports and provide the user with acoustical information from the system, while protecting him from environmental sounds. Ambient sound microphones 16, 17, 16a, and 17a are likewise connected to the side/ear supports as shown and are directed away from the user to provide the system with ambient acoustical information as described hereinbelow. A boom microphone 20 is supported by one of the side/ear supports and functions to receive user speech and to input the speech to the system, as further described hereinbelow. Mixing audio output units 22, 22a are connected to the side/ear supports as shown. Flexible connectors 26, 26a connect the earphones to the mixing audio output units. More details about the flexible connectors, earphones, and mixing audio output units are provided hereinbelow. One or more additional ambient sound microphones 30 is optionally configured on the rear head support, facing rearwards, and provides additional ambient acoustical information to that of ambient sound microphones 16, 17, 16a, and 17a. Alternatively or optionally, additional ambient sound microphones may be mounted on the headset (ie on the rear support and/or on the side/ear supports) facing away from the user.

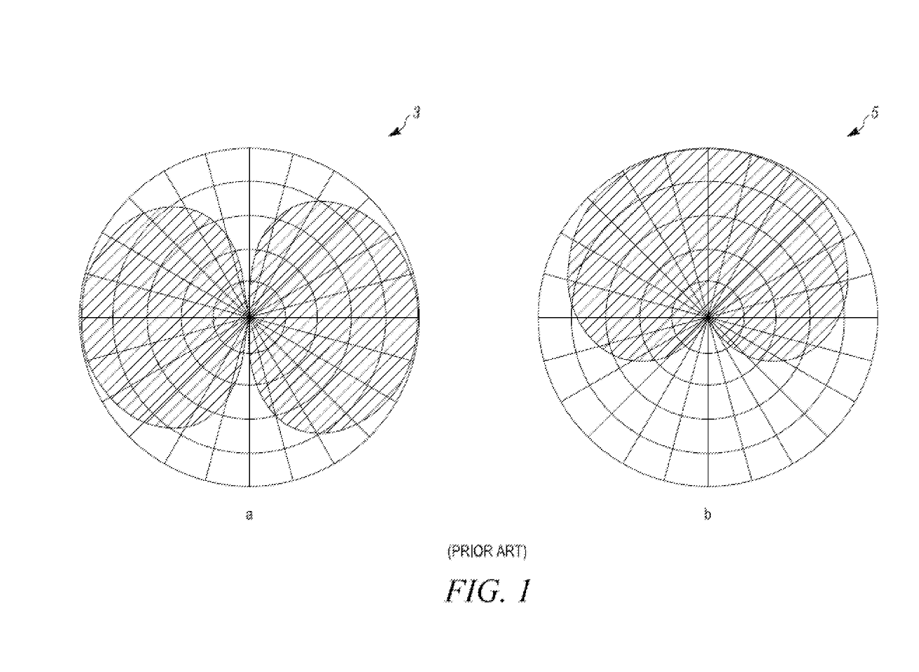

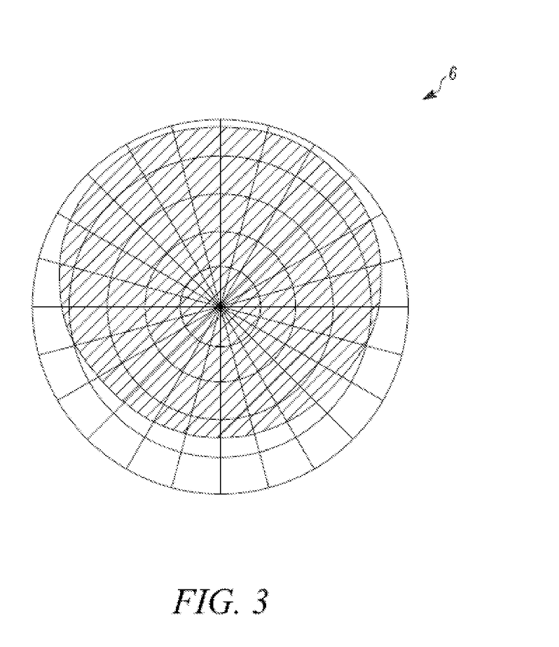

Reference is now made to FIG. 3, which is a qualitative polar coordinate representation 6 of direction and intensity situational awareness provided by system 10 of FIGS. 2A and 2B, in accordance with embodiments of the current invention. Apart from differences described below, polar coordinate representation 6 is generally similar to the representations shown in FIG. 1. Unlike representations 3 and 5 of FIG. 1, representation 6 in FIG. 3 shows a more uniform distribution of sensitivity, corresponding to the situation awareness provided by system 10, having the two sets of side-mounted microphones as well as a one or more additional ambient sound microphones 30. A discussion as to how increased sensitivity and uniformity are achieved follows hereinbelow.

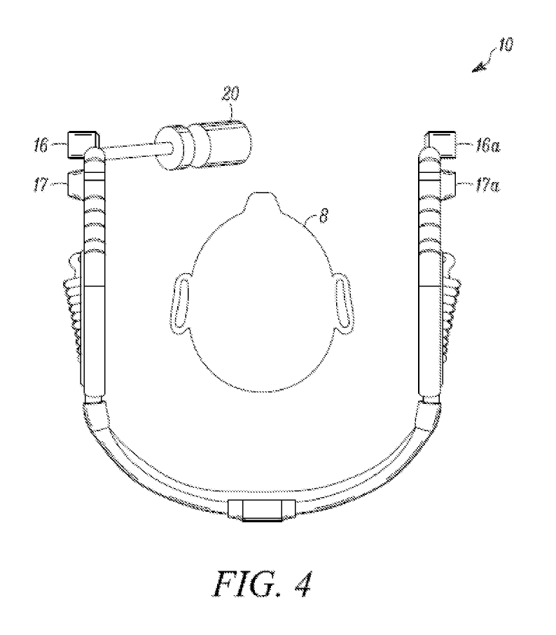

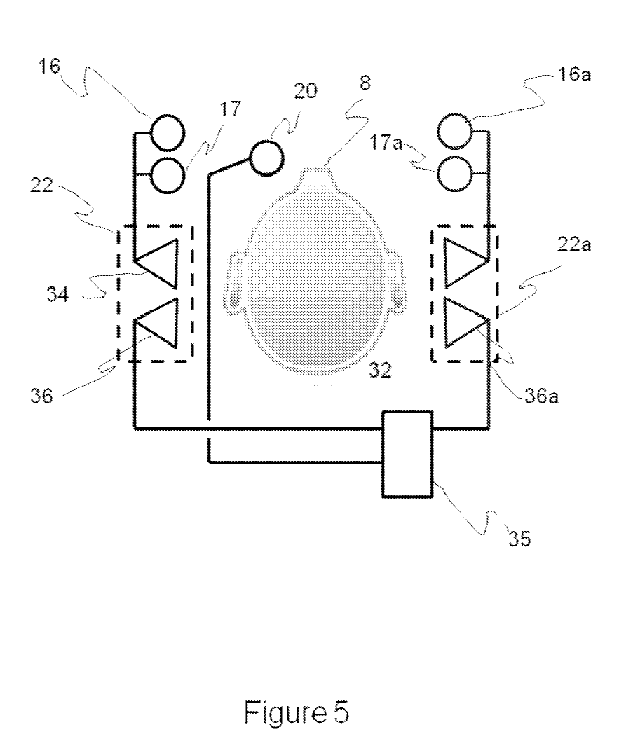

Reference is now made to FIGS. 4 and 5, which are pictorial and schematic representations, respectively, of system 10 and user 8 of FIGS. 2A and 2B, in accordance with embodiments of the current invention. Apart from differences described below, system 10 and user 8 are generally similar to the system and user respectively shown in FIGS. 2A and 2B. System 10 includes elements generally identical in configuration, operation, and functionality as described hereinabove. As noted previously, ambient sound microphones 16, 17, 16a, and 17a (and additional ambient sound microphones 30, if present) provide the system with ambient acoustical information. The information is processed digitally by signal processing subsystem (not show in the figure and further described hereinbelow). The processed acoustical information is combined and outputted respectively to ambient sound acoustical output devices 34 and 34a.

In the specification and claims which follow, the term “acoustical output device” as used in conjunction with the low-power consumption, talk-through system, is intended to mean a typical speaker which is sufficiently small can fit into mixing audio output units 22, 22a. Alternatively, “acoustical output device” is intended to mean an acoustical device which can feed its electronic signal either into an electronic mixing device (not shown in the figures) to eventually provide an audible sound to the user. Whereas the description hereinbelow relates to typical speakers and to audible audio mixing, it should be apparent to one skilled in the art that the description is likewise adaptable and applicable to electronic audio mixing.

An external device 35, such as but not limited to a transceiver radio or another communications means which can provide an audio signal, can also be connected to the system.

Although external device 35 is indicated in the singular—which is a typical application—one or more such devices may be used together with the system and their audio outputs are combined. Therefore the term “external device” in the specification and claims which follow is intended to mean one or more communication devices.

The external device provides output to communications acoustical output devices 36 and 36a. Boom microphone 20 transfers the user's speech directly to the external device for communications purposes, as shown in the figures. Consequently, the user's speech is also transferred through the external device to communications acoustical output devices 36 and 36a. Respective ambient sound and communications acoustical outputs are mixed in respective mixing audio output units 22 and 22a to provide mixed audio outputs to the earphones (shown in FIGS. 2A and 2B, but not in the current figure) and to the user's ears. In this way, the audio information from both the environment and from the external device is conditioned and transferred to the user.

Furthermore, because ambient sound acoustical output devices 34, 34a and the communications acoustical output devices 36, 36a are separated, should electronics components of the system catastrophically fail causing a loss of “talk through”, external device communications (for example, radio communications) remains independent and is maintained.

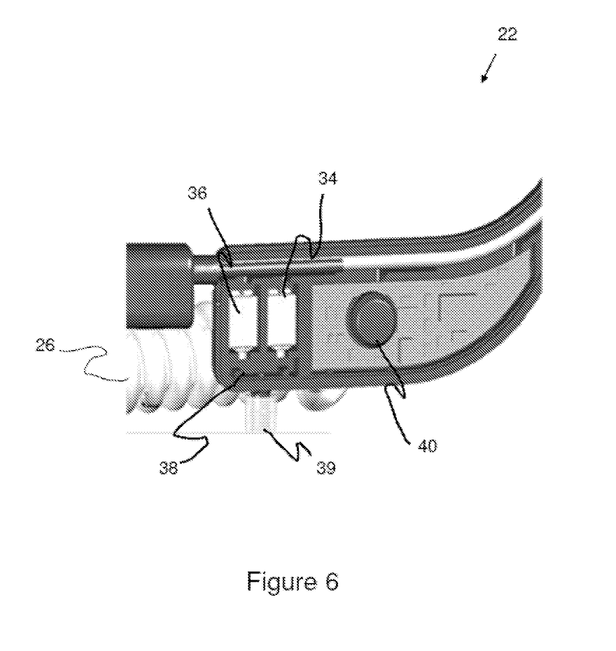

Reference is presently made to FIG. 6, which is a pictorial representation of mixing audio output unit 22 (and 22a) with external cover removed, in accordance with embodiments of the current invention. Apart from differences described below, mixing audio output unit 22 (and 22a) is generally similar to the unit(s) shown in FIGS. 2B and 5 hereinabove.

Sound mixing chamber 38 is formed within mixing audio unit 22 to mix output from ambient sound acoustical output device 34 and communications acoustical output device 36. A connection nipple 39 communicating with sound mixing chamber 38 serves to mechanically/acoustically connect flexible connector 26, which in turn is connected to earphone 14. Flexible connector 26 may be easily released/replaced from the connection nipple by pulling and disconnecting flexible connector 26 at connection nipple 39 and replacing the flexible connector with a new one. Button 40 is located on mixing audio unit and the button serves as a single control button to control system functions including volume and other modes of operation.

In one embodiment of the current invention, wherein miniature speakers are employed for both the ambient sound acoustical output and communications acoustical output devices, the sound mixing chamber is configured as described hereinabove and flexible connector 26 has the form of a hollow coiled acoustic tube to transfer audible output to the headphone and user. The speaker-acoustic-tube configuration of this embodiment has specific advantages—as compared to electronic configurations—in that acoustic tubes are immune to RF interference which could corrupt the audio information. Additionally, should a tube be damaged/break or there is a need to change it for sanitary reasons, it can be easily replaced due to its low cost.

In another embodiment of the current invention, all or part of the ambient sound acoustical output and communications acoustical output devices, the sound mixing chamber, the flexible connector, and the earphone are in the form of electric/electronic devices, as known in the art.

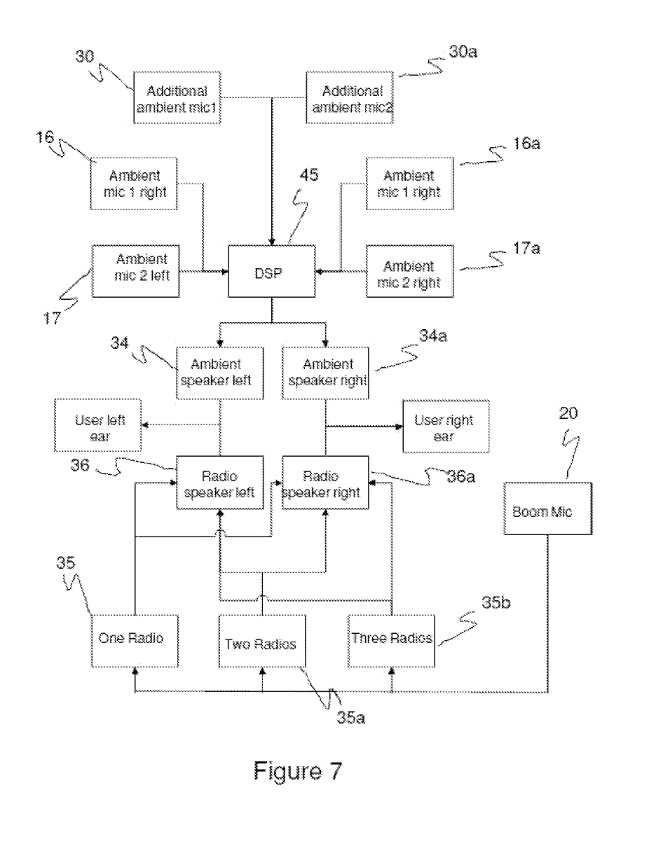

Reference is presently made to FIG. 7 is a block/interconnection diagram of the low-power consumption, talk-through system of FIGS. 2A and 2B, in accordance with embodiments of the current invention. Apart from differences described below, the system includes elements generally identical in configuration, operation, and functionality as described hereinabove.

The block diagram serves to summarize discussion of the system hereinabove while emphasizing the interconnection and functionalities of some system components.

One or more additional ambient sound microphones 30, 30a and ambient sound microphones 16, 17, 16a, and 17a all feed their respective outputs to a signal processing subsystem 45 (indicated “DSP”). The signal processing subsystem filters respective microphone output signals, taking advantage of digital signal processing (DSP) hardware and software.

In one embodiment of the current invention, the system has neither batteries nor any on-board power source. Having a very low power requirement, less than 6 mW, power may be obtained from the external device (such as, but not limited to a radio) or an inline battery pack. One reason for the very low consumption of the system is the use of a low power consumption DSP chip (not shown in the figure) used in the signal processing subsystem.

As noted hereinabove, the system may obtain its power from a radio. A typical military radio has a battery with a typical charge capacity of about 4,000 mAH. In an embodiment of the current invention, the system is designed to have a peak current “draw” of 3 mA (corresponding to a peak power consumption of 6 mW). It can be seen that in 1 hour of continuous peak current operation of the system, yielding a total charge capacity use of 3 mAH, the system would use less than approximately 0.1% of the radio battery capacity. Such a very low-power parasitic use of the external device (ie, a radio) power source is considered acceptable.

Embodiments of the current invention employed in the signal processing system include ADR and Tinnitus treatment, inter alia, as noted hereinbelow.

Adaptive Noise Reduction (ANR)

With a four-microphone ambient configuration, as described hereinabove, constant noises can be suppressed by up to 12 dB, as one of the two ambient microphones on either side of the head acts as a reference microphone. This noise suppression functionality is similar to that of a typical boom microphone.

ADR allows for finer resolution noise removal from a composite audio signal while enhancing the speech component of the signal due to proprietary psycho-acoustics employed in the algorithm. ADR serves to automatically reduce the acoustic level of sound sources located behind or from the side of the headset wearer by adjustment of the null in the microphone polar intensity pattern (ie FIG. 3) to minimize the noise level outputted to the user. The automatic steering of the null provides improved signal-to-noise ratio of the resultant audio output.

Tinnitus Treatment

Tinnitus is a well-known form of hearing damage characterized by ringing in the ears. The signal processing system has a noise generator that can be used in treating the effects tinnitus while wearing the headset, as known in the art. The tinnitus treatment acoustical pattern can be shaped and attenuated and then summed into the audio path either before or after the volume control.

Following signal processing as described hereinabove, signal processing subsystem 45 outputs respective signals to sound acoustical output devices 34 and 34a and to the user's respective right and left ears, as shown in the figure.

As noted hereinabove, one or more external devices 35, 35a, and 35b can be used and their respective outputs signals are transferred to communications acoustical output devices 36 and 36a and to the user's respective right and left ears, as shown in the figure.

Boom microphone 20 directly connects to or more external devices 35, 35a, and 35b. The boom microphone configuration of the system is preferable for a number of reasons, as described hereinbelow. Prior art talk-through systems use an in-ear ECM (Electret Condenser Microphone) to handle voice communications and environmental sound (ie “talk through”). The combination of voice and talk-through in one microphone is problematic for the following reasons:
1. Equipment vibrations that are transferred through the body as well as vibrations causes by running can be transmitted over the in-ear microphone;
2. Other voices (other than that of the user) in close proximity to the user can be transmitted over the external device/radio;
3. Whispering is not handled well; and
4. Transmissions by radio in loud/windy environments is not typically clear.

As noted hereinabove, earphones 14 and 14a serve additionally to shield out the strong acoustical background noise to the user. One embodiment of the current invention makes use of an earplug tip rated at 32-39 NRS (Noise Reduction Statistic ANSI S12.6 2008).

It will be appreciated that the above descriptions are intended only to serve as examples, and that many other embodiments are possible within the scope of the present invention as defined in the appended claims.

1. A low-power consumption, talk-through system comprising:
a headset worn by a user on his head, the headset further comprising:
an array of at least 2 sets of 2 ambient sound microphones, each set positionable on each side of the head;
a signal processing subsystem adapted to process respective electrical signals from the microphones and to provide respective outputs having acoustical source distance and intensity information;
at least 4 acoustical output devices connectable to the signal processing subsystem, the respective acoustical output devices driven by the respective outputs of signal processing subsystem; and
no on-board power source,
wherein the user is provided with enhanced situational awareness and near human sound localization by the system.

2. The system according to claim 1, wherein the system power consumption is below a peak value of 6 milliwatts.

3. The system according to claim 2, wherein the system obtains its power from an external device.

4. The system according to claim 3, wherein the external device is chosen from the list including: a transceiver radio; and a communications device having audio input/output.

5. The system according to claim 4, wherein one or more additional ambient sound microphones are positionable on the headset with orientations chosen from the list including: back of the head and sides of the head.

6. The system according to claim 5, wherein at least one mixing audio output unit is positionable on the headset to receive outputs from the signal processing subsystem and from the external device, the at least one mixing audio output unit connectable to an earphone to provide external device and ambient audible sound to the user.

7. The system according to claim 2, wherein the system obtains its power from an external battery.

8. A method for using a low-power consumption talk-through system, the system not having an on-board power source, including the steps of:
taking a headset worn by a user on his head;
configuring on the headset an array having at least 2 sets of 2 ambient sound microphones positioned on each side of the head;
using a signal processing subsystem to process respective electrical signals from the microphones and to provide respective outputs having acoustical source distance and intensity information; and
connecting at least 4 acoustical output devices to the signal processing system, the respective acoustical output devices driven by the respective outputs of signal processing subsystem,
wherein the user is provided with enhanced situational awareness and near human sound localization by the system

9. The method of claim 8, wherein the system power consumption is below a peak value of 6 milliwatts.

10. The method of claim 9, whereby the system obtains its power from an external device.

11. The method of claim 10, wherein the external device is chosen from the list including: a transceiver radio; and a communications device having audio input/output.

12. The method of claim 11, whereby one or more additional ambient sound microphones are positioned on the headset with orientations chosen from the list including: back of the head and sides of the head.

13. The method of claim 12, whereby at least one mixing audio output unit is positioned on the headset to receive outputs from the signal processing subsystem and from the external device, the at least one mixing audio output unit is connected to an earphone to provide external device and ambient audible sound to the user.

14. The system according to claim 9, wherein the system obtains its power from an external battery.

15. A low-power consumption, talk-through system comprising:
a headset worn by a user on his head, the headset further comprising:
an array of at least 2 sets of 2 ambient sound microphones, each set positionable on each side of the head;
an in-ear earphone adapted to attenuate environmental sound and to provide system audio to the user; and
a boom microphone substantially isolated from the user's body vibrations, the boom microphone adapted to attenuate environmental sound and to receive user speech;
wherein the user is provided with enhanced situational awareness and near human sound localization by the system.
